(19) United States
(12) Patent Application Publication
(10) Pub. No.: US 2016/0052353 A1
(43) Pub. Date: Feb. 25, 2016

(54) NONSLIP CIRCULAR FLANGE

(71) Applicant: Sang Gwang JUNG, (US)

(72) Inventor: Sang Gwang Jung, Gyeonggi-do (KR)

(21) Appl. No.: 14/764,068

(22) PCT Filed: Jan. 27, 2014
(86) PCT No.: PCT/KR2014/000730

§ 371 Date: Sep. 18, 2015

(30) Foreign Application Priority Data
Jan. 29, 2013 (KR) 10-2013-0009903

(51) Int. Cl. B60C 27/20

(52) U.S. Cl. CPC B60C 27/20

(57) ABSTRACT

The present invention discloses a nonslip device for preventing a vehicle from falling into a difficult situation causing the vehicle to be unable to move or be controlled because of slipping between the tires and the road, characterized by comprising: a fixing plate for fastening a nonslip circular flange onto the wheel axle or an aluminum wheel; a middle circular flange with a middle spoke assembly connected to a fixing circular flange formed perpendicular to the surface of the fixing plate so as to strengthen the nonslip circular flange by preventing it from being twisted or bent; a resilient body part arranged between the middle circular flange and a frictional circular flange for imparting resilience to the nonslip circular flange, the frictional circular flange enhancing the frictional resistance to a slippery road surface; and an assisting device for quickly and easily mounting the device to the vehicle.

### TECHNICAL FIELD

The present invention relates to a structure and a device of a nonslip device for a vehicle, and more particularly, to a nonslip device for a vehicle, which has a structure to be easily installed by anyone and has excellent convenience and efficiency with respect to installing the nonslip device in order to prevent a vehicle from slipping due to snow or ice while being driven.

### BACKGROUND ART

Generally, a snow chain is a vehicle assist device for safe driving, which has been used to prevent a slip on a snowy road.

However, it is quite troublesome and difficult to lift an unclean car body and mount a chain on a wheel, regardless of age or sex, based on use conditions of a vehicle.

Moreover, the number of casualties and material damage of people caused by a slip while driving a vehicle during winter are considerable, the number of drivers avoiding the use of a snow chain due to inconvenience of mounting the snow chain is increasing, and environmental destruction, cost increase, road damages, and vehicle corrosion are aggravated due to massive use of calcium chloride for snow removal.

Recently, spray products and rubber products have been manufactured to improve some of the above problems, but nonslip effects thereof are insignificant or a great deal of inconvenience still remains, and thus the number of users has not largely increased and damages caused by a slip while driving a vehicle are considerably high.

### DISCLOSURE OF THE INVENTION

### Technical Problem

The present invention provides a nonslip device for a vehicle, which is easily used and has a fine appearance, an excellent nonslip effect, and an excellent durability, so as to increase benefits of individuals and in addition, decrease losses of social costs by enabling a user to easily and quickly mount the nonslip device onto the vehicle without spoiling the clothes when the user wishes to safely drive the vehicle by using a chain on a slippery road, such as a snowy or icy road during winter, or sometimes, when the user wishes to increase frictional resistance of wheels and escape from a situation in which the vehicle is stuck in sand or mud and the wheels spin with no traction.

### Technical Solution

According to an aspect of the present invention, there is provided a nonslip device including: a nonslip circular flange 100; a fixing plate 110 fastening the nonslip circular flange 100 onto a wheel axle; a middle spoke assembly 121 and a middle circular flange 120 connected to a fixing circular flange 111 of the fixing plate 110 so as to strengthen the nonslip circular flange 100 by preventing the nonslip circular flange 100 from being twisted or bent; a resilient body part 130 arranged between the middle circular flange 120 and a frictional circular flange 140 to impart uniform resilience to the nonslip circular flange 100; the frictional circular flange 140 enhancing frictional resistance through a drainage hole 142 and a frictional circular flange protrusion 141; and an assisting device 300 for quickly and easily mounting the nonslip device to a vehicle.

### Advantageous Effects

According to the present invention, a utilization rate of a nonslip device is high according to excellent convenience, and damage costs of individuals may be decreased and in addition, social costs may be largely reduced as the utilization rate of the nonslip device is high while a vehicle is driven.

### BRIEF DESCRIPTION OF THE DRAWINGS

FIG. 1 is a plan cross-sectional view of a nonslip device according to an embodiment of the present invention.

FIG. 2 is a perspective view of an outer diameter of a frictional circular flange to be compared with a size of a tire while contacting a road, according to an embodiment of the present invention.

FIG. 3 is a partial cross-sectional view of a drainage hole of a frictional circular flange, according to an embodiment of the present invention.

FIGS. 4A and 4B are partial cross-sectional views of a shape of each resilient body part after a nonslip device is being mounted onto a vehicle, according to embodiments of the present invention.

FIG. 5 is a cross-sectional view of an assisting device according to an embodiment of the present invention.

### MODE FOR CARRYING OUT THE INVENTION

Hereinafter, the present invention will be described in detail with reference to accompanying drawings. The invention may, however, be embodied in many different forms and should not be construed as being limited to embodiments set forth herein; rather, these embodiments are provided so that this disclosure will be thorough and complete, and will fully convey the concept of the invention to those skilled in the art.

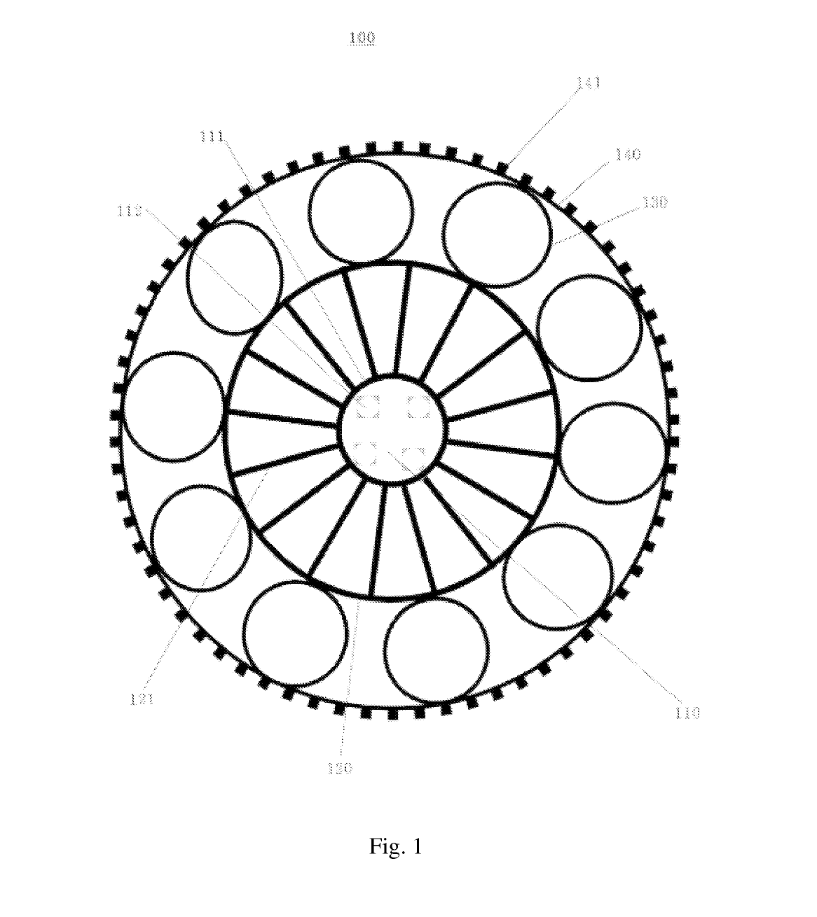

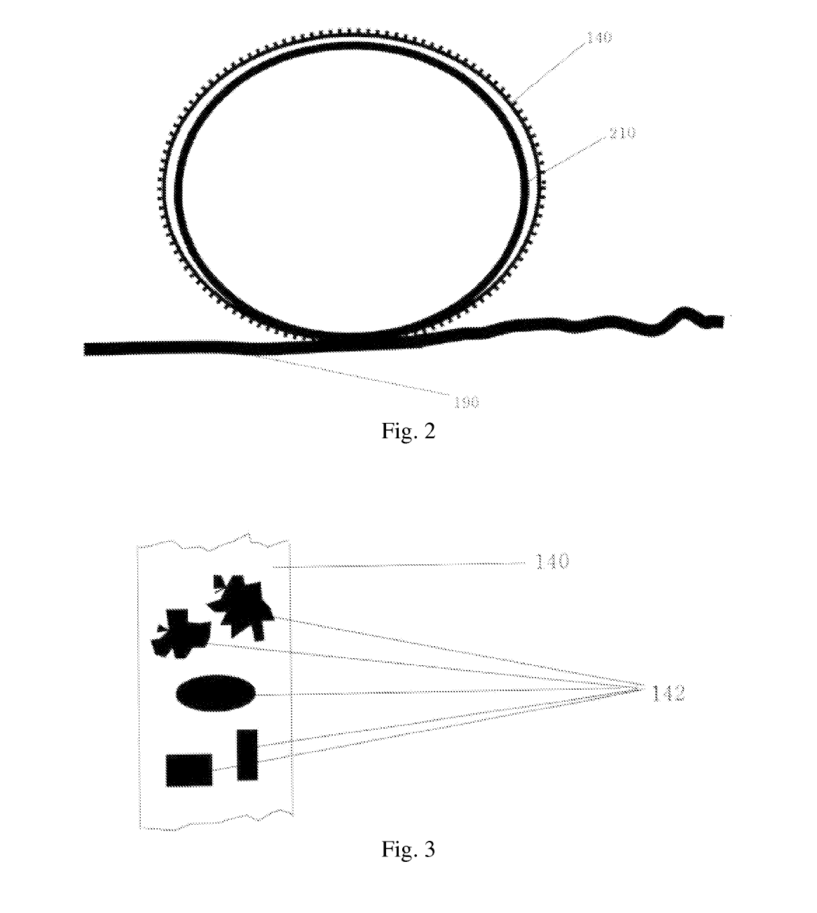

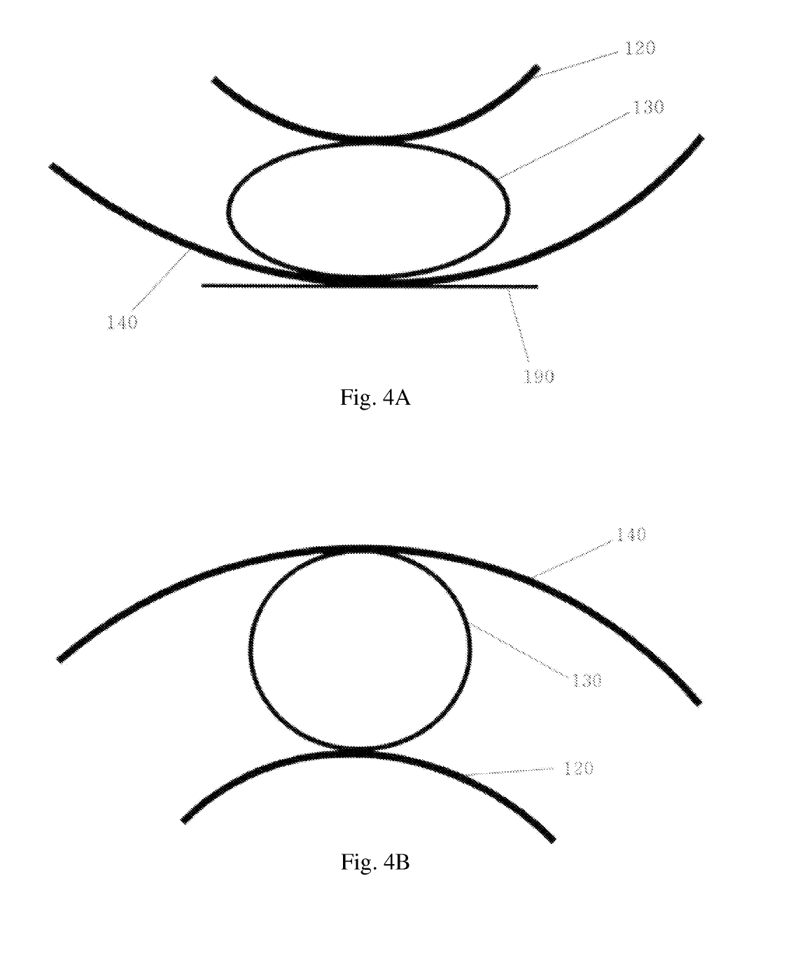

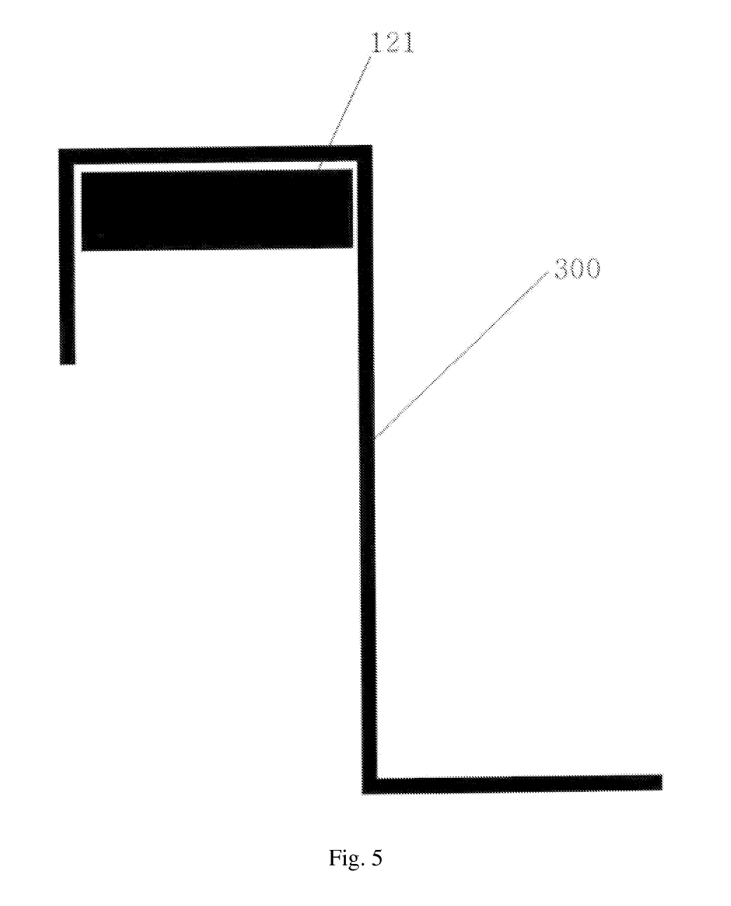

FIG. 1 is a plan cross-sectional view of a nonslip circular flange according to an embodiment of the present invention, FIG. 2 is a perspective view of an outer diameter of a frictional circular flange to be compared with a size of a tire while contacting a road, according to an embodiment of the present invention, FIG. 3 is a partial cross-sectional view of a drainage hole of a frictional circular flange, according to an embodiment of the present invention, and FIGS. 4A and 4B are partial cross-sectional views of a shape of each resilient body part after a nonslip device is being mounted onto a vehicle, according to embodiments of the present invention, and FIGS. 5 is a cross-sectional views of an assisting device according to an embodiment of the present invention.

As shown in FIGS. 1 through 5, a nonslip device according to an embodiment of the present invention may include a fixing plate 110 for fastening a nonslip circular flange 100 onto a wheel axle by using a nut, a fixing circular flange 111 connected perpendicularly to a surface of the fixing plate 110 and binding and fixing each end of a plurality of middle spoke assemblies 121, the middle spoke assemblies 121 and a middle circular flange 120 lightening the nonslip circular flange 100 and preventing the nonslip circular flange 100 from being twisted and bent, a plurality of resilient body parts 130 provided between the middle circular flange 120 and a frictional circular flange 140 to impart flexibility and resilience required for installation and driving with uniform elasticity, the frictional circular flange 140 connected to each end of the resilient body parts 130, enhancing frictional resistance via a drainage hole 142 formed therein and a frictional circular flange protrusion 141, and increasing a grip force with respect to a slippery road 190 by having an outer diameter larger than an outer diameter of a tire 210, and an assisting device 300 for easily mounting the nonslip device to a vehicle.

Here, since connecting the fixing plate 110 to the wheel axle by using a bolt and a nut is a well-known technology, descriptions thereof are not provided. The fixing circular flange 111 perpendicularly connected to one end of the middle spoke assembly 121 may be a circular flange having a uniform width and a uniform thickness, may be formed of steel, and may be perpendicularly connected to a surface of the fixing plate 110.

The plurality of middle spoke assemblies 121 may be provided at uniform intervals, each end of the plurality of middle spoke assemblies 121 may be perpendicularly connected to an inner side surface of the middle circular flange 120, and the plurality of middle spoke assemblies 121 may be formed of steel.

In order to prevent the nonslip circular flange 100 from being bent due to frictional force of the frictional circular flange protrusions 141 generated when a vehicle sliding sideways tries to stop, the middle circular flange 120, the frictional circular flange 140, and the middle spoke assembly 121 may be formed of steel, and thicknesses and widths may be uniform from the middle spoke assembly 121 to the resilient body parts 130. The thicknesses and widths may vary in proportion to a size or a weight of the vehicle.

The resilient body parts 130 are basically formed of a metallic material having flexibility required when pressure is applied to the frictional circular flange 140 facing the middle circular flange 120 by using pliers, and resilience to exert a compression force towards a road when the resilient body part 130 is suppressed towards the ground by the weight of the vehicle after being mounted to the vehicle, such that a diameter of the nonslip circular flange 100 having the outer diameter larger than that of the tire 210 is reduced to be easily mounted to the vehicle, but occasionally, each of the resilient body parts 130 may be a rubber product, and may be circular.

In order to increase a frictional force, the frictional circular flange 140 may include a plurality of the frictional circular flange protrusions 141 and a plurality of the drainage holes 142 on a rotating surface contacting the road, and may be formed of an elastic metal. Also, the frictional circular flange protrusion 141 that may be formed of steel may be attached to and detached from the frictional circular flange 140, and may be provided in a rotary screw manner.

With respect to the pliers used to mount the nonslip device to the vehicle, the assisting device 300 used by being hooked on certain regions of the two circular flanges 120 and 140 may be provided such that the certain regions of the two circular flanges 120 and 140 are compressed even with small vice pliers.

While manufacturing the nonslip circular flange 100, each component that is not specified herein may be connected to the nonslip circular flange 100 via welding.

While the present invention has been particularly shown and described with reference to exemplary embodiments thereof, it will be understood by those of ordinary skill in the art that various changes in form and details may be made therein without departing from the spirit and scope of the present invention as defined by the following claims.

1. A nonslip device for a vehicle, the nonslip device comprising:
a fixing plate having a hole to be fixed to a rotation shaft extension of a vehicle wheel or to an aluminum wheel by using a bolt and a nut;
a fixing circular flange and a middle spoke assembly connecting a middle circular flange and the fixing plate and lightening and strongly connecting a nonslip circular flange;
the middle circular flange fixing each end of a plurality of resilient body parts provided at regular intervals in a circle;
the plurality of resilient body parts provided between the middle circular flange and a frictional circular flange, and having, owing to uniform elasticity of a material, flexibility and resilience required to mount the nonslip device to the vehicle and enhance a frictional force on a slippery road;
the frictional circular flange connected to each end of the plurality of resilient body parts, enhancing frictional resistance via a drainage hole formed therein and a frictional circular flange protrusion, and increasing the frictional resistance by contacting a slippery road surface in an oval shape as an outer diameter of the frictional circular flange is larger than an outer diameter of a tire;
the drainage hole discharging water, snow, sand, or mud;
a plurality of the frictional circular flange protrusions formed on a surface of the frictional circular flange to cause frictional resistance between the slippery road surface and the fictional circular flange; and
an assisting device used to decrease an interval between the two circular flanges by hooking the assisting device on certain regions of the two circular flanges such that the certain regions of the two circular flanges are compressed with small vice pliers with respect to pliers used to mount the nonslip circular flange to the vehicle.

2. The nonslip device of claim 1, wherein the plurality of resilient body parts are provided in rubber products when a vehicle is a subcompact car.

3. The nonslip device of claim 1, wherein the plurality of frictional circular flange protrusions is intensive consumables and is replaceable.

4. A nonslip device for a vehicle, the nonslip device comprising:
a fixing plate having a hole to be fixed to a rotation shaft extension of a vehicle wheel or to an aluminum wheel by using a bolt and a nut;
a fixing circular flange and a middle spoke assembly connecting a middle circular flange and the fixing plate and lightening and strongly connecting a nonslip circular flange;
a plurality of resilient body parts provided between the middle circular flange and a frictional circular flange, the middle circular flange fixing each end of the plurality of resilient body parts provided at regular intervals in a circle, the frictional circular flange connected to each end of the plurality of resilient body parts;
a plurality of the frictional circular flange protrusions formed on a surface of the frictional circular flange; and
an assisting device used to decrease an interval between the two circular flanges by hooking the assisting device on certain regions of the two circular flanges such that the certain regions of the two circular flanges are compressed with small vice pliers with respect to pliers used to mount the nonslip circular flange to the vehicle.

5. The nonslip device of claim 4, wherein the plurality of resilient body parts are provided in rubber products when a vehicle is a subcompact car.

6. The nonslip device of claim 4, wherein the plurality of frictional circular flange protrusions is intensive consumables and is replaceable.

7. The nonslip device of claim 4, the frictional circular flange includes a plurality of drainage holes formed on the surface of the frictional circular flange.

8. The nonslip device of claim 7, the drainage holes discharge water, snow, sand, or mud.
